(19) United States
(12) Patent Application Publication
(10) Pub. No.: US 2012/0182981 A1
(43) Pub. Date: Jul. 19, 2012

(54) TERMINAL AND METHOD FOR SYNCHRONIZATION

(75) Inventor: Sang-Myoung KIM, Seoul (KR)

(73) Assignee: PANTECH CO., LTD., Seoul (KR)

(21) Appl. No.: 13/229,023

(22) Filed: Sep. 9, 2011

(30) Foreign Application Priority Data
Jan. 13, 2011 (KR) 10-2011-0003512

(51) Int. Cl. H04W 84/02; H04J 3/06

(52) U.S. Cl. 370/338; 370/503; 370/350

(57) ABSTRACT

A terminal which is compatible with another terminal and is capable of performing data synchronization without a separate server, and a synchronization method using the same is disclosed. The terminal may directly connect to another terminal and receive data therefrom. The received data is synchronized with the terminal. If the received data does not suit the playback environment of the terminal, a playback tool or conversion tool may be received from a server.

### CROSS-REFERENCE TO RELATED APPLICATION

This application claims priority from and the benefit under 35 U.S.C. §119(a) of Korean Patent Application No. 10-2011-0003512, filed on Jan. 13, 2011, which is incorporated by reference for all purposes as if fully set forth herein.

### BACKGROUND

1. Field

The following description relates to a terminal to perform and a method for performing data synchronization, and in particular to a terminal to perform and a method for performing data synchronization with another terminal.

2. Discussion of the Background

Recently, as a wireless network technique and an infrastructure thereof have been rapidly developed, people can obtain desired data using a mobile terminal, such as a smart phone, a laptop computer, a personal digital assistant (PDA), etc., anywhere at any time. In particular, the smart phone has not only a mobile phone operation but also an information technology (IT) device operation. For efficient data management, there is a need for data synchronization with another IT device.

“My Phone” of Microsoft Corporation, which is a representative IT device synchronization tool, may be used in mobile phones for executing an operation system (OS) of Window Mobile® 6 or higher. Synchronization services provided by “My Phone” include a service for automatically backing up mobile phone data, a service for sending a photo to a personal computer (PC) and uploading the photo to a social network service (SNS) site, synchronization of a photo file, a moving image file or a music file, finding of a lost mobile phone, and confirmation of an online mobile telephone address book or Short Message Service (SMS). In particular, a service for providing online synchronization data is provided using a server for storing data.

However, the synchronization tool “My Phone” works with a “Windows Mobile®” platform and may not perform synchronization with devices using other platforms. In addition, since synchronization is performed using a server, if the server is disabled, synchronization is impossible. Furthermore, there may be restrictions on synchronization according to traffic state or reception sensitivity of the server.

### SUMMARY

Exemplary embodiments of the present invention provide a terminal, which is compatible with another device and is capable of performing data synchronization without a separate server, and a synchronization method using the same.

Additional features of the invention will be set forth in the description which follows, and in part will be apparent from the description, or may be learned by practice of the invention.

An exemplary embodiment of the present invention discloses a terminal including: a communication unit configured to transmit data and/or receive data from a server or a second terminal; and a controller configured to directly receive data of the second terminal through the communication unit based on an Internet Protocol (IP) and convert the received data into a format appropriate for a playback environment of the terminal to perform synchronization.

An exemplary embodiment of the present invention discloses a data synchronization method, including: directly accessing a terminal through a communication unit based on an Internet Protocol (IP); receiving data from the terminal; determining whether the received data is appropriate for a playback environment; and if it is determined that the received data is not appropriate for the playback environment, converting the received data into a format appropriate for the playback environment.

An exemplary embodiment of the present invention discloses a data synchronization method, including: directly accessing a terminal through a communication unit based on an IP; receiving data from the terminal; determining whether the received data suits a playback environment; receiving a playback tool from a server through the communication unit, if it is determined that the received data does not suit the playback environment; and performing synchronization of the received data using the received playback tool.

It is to be understood that both the foregoing general description and the following detailed description are exemplary and explanatory and are intended to provide further explanation of the invention as claimed. Other features and aspects will be apparent from the following detailed description, the drawings, and the claims

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of a terminal according to an exemplary embodiment.

FIG. 2 is a diagram illustrating a method of directly connecting a terminal to another terminal according to an exemplary embodiment.

FIG. 3 is a flowchart illustrating a method for data synchronization according to an exemplary embodiment.

### DETAILED DESCRIPTION

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of elements and regions may be exaggerated for clarity. Like reference numerals in the drawings denote like elements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that when an element or layer is referred to as being “connected to” another element, it can be directly on or directly connected to the other, or intervening elements or layers may be present. In contrast, when an element is referred to as being “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

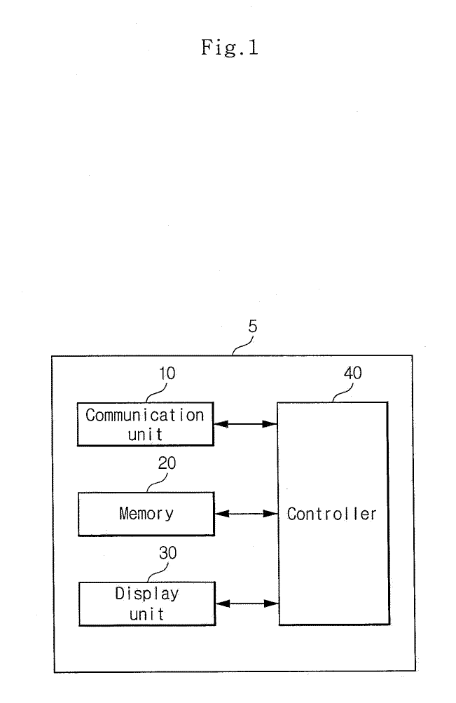

FIG. 1 is a diagram of a terminal according to an exemplary embodiment.

Referring to FIG. 1, a terminal 5 according to an exemplary embodiment includes a communication unit 10, a memory 20, a display unit 30 and a controller 40.

The terminal 5 may be a mobile communication terminal, such as a Personal Digital Assistants (PDA), a smart phone, a navigation terminal, etc. or a personal computer, such as a desktop computer, a tablet, a notebook, ultra mobile personal computers (UMPCs), etc., a television, or other information technology (IT) device. The communication unit 10 may include an antenna built in the terminal 5 and transmits data and/or receives data from another terminal or a server. The terminal 5 may perform TCP/IP communication with another terminal through the communication unit 10. Another terminal may be a mobile communication terminal, such as a PDA, a smart phone, a navigation terminal, etc. or a PC, such as a desktop computer, a tablet, a notebook, ultra mobile personal computers (UMPCs), etc., a television, or other information technology device, etc. The server may be an intranet server, an internet server, a cloud computing service, etc.

The memory 20 synchronizes and stores data received from another terminal and/or receives and stores a playback or reproduction tool or a conversion tool from a server. The memory 20 may also store data, a playback tool or a conversion tool in the terminal 5.

The display unit 30 displays various operation statuses of the terminal 5. In particular, the display unit 30 may display a synchronization operation status. For example, a user interface (UI) representing a synchronization status may be displayed on an upper portion of the display unit 30. If a user clicks on the UI, a screen may pop-up that displays a current synchronization status and a progress rate, which may be represented by a progress bar.

The controller 40 directly receives data from another terminal through the communication unit 10 based on an Internet Protocol (IP) and converts the received data into a format suitable for a playback environment of the terminal 5, thereby performing synchronization.

According to aspects of the present invention, the term “synchronization” may refer to the operation whereby data stored in another terminal is received and stored in a format which can be reproduced. Synchronization may be performed passively or at specific intervals such that the terminal stores the same data as the data stored in another terminal.

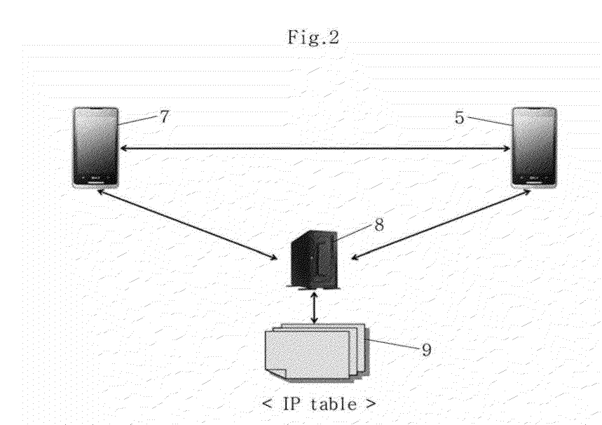

The terminal 5, according to an exemplary embodiment, is directly connected to another terminal based on the IP without a separate external server, which will be described in detail with reference to FIG. 2.

FIG. 2 is a diagram illustrating a method of directly connecting a terminal to another terminal according to an exemplary embodiment.

A terminal, by way of example, a smart phone, receives an IP address allocated thereto and performs fast synchronization with another terminal using an IEEE 802.11 wireless communication scheme, such as 802.11 a/b/g/n. A terminal connection method may be changed depending on whether the terminal employs a 3G communication scheme or a 4G communication scheme.

If the terminal employs a 4G communication scheme, since each terminal has a unique IP address, the terminal may be immediately connected to another terminal without a separate setting. In contrast, if the terminal employs a 3G communication scheme, the terminal accesses a server having a unique IP address and acquires an IP address after booting up.

In other words, referring to FIG. 2, if the terminal 5 and a terminal 7 employ a 4G communication scheme, the terminal 5 may be directly connected to the terminal 7, which is a host, to perform data transmission/reception. If the terminal 5 and the terminal 7 employ a 3G communication scheme, the terminal 5 accesses an IP server 8 having an IP table 9 of unique IP addresses, receives an IP address from an IP address table 9, and acquires the IP address of the terminal 7, thereby connecting the terminal 5 and the terminal 7. The IP server 8 is used to acquire the IP address, the terminal 5 is connected to an IEEE 802.11 wireless LAN after IP address acquisition, thereby achieving high-speed data transmission.

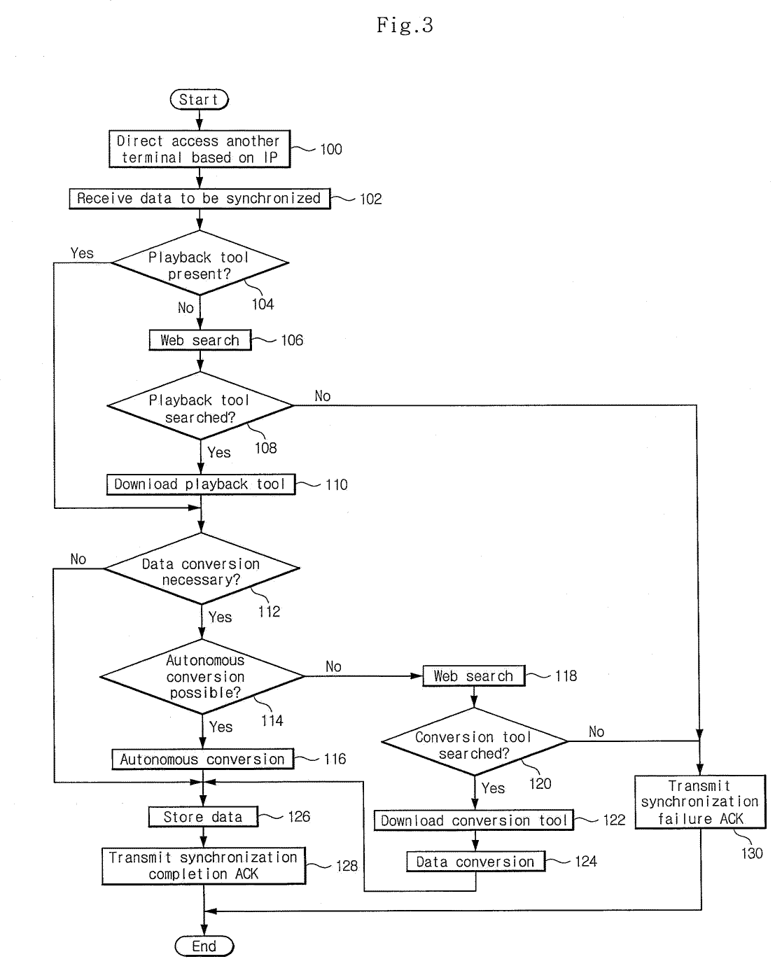

As described with reference to FIG. 2, if the terminal 5 and the terminal 7 are directly connected based on the IP address, the controller 40 determines whether a data conversion is needed or a playback tool or a conversion tool needs to be downloaded. The controller 40 performs any needed operations, thereby performing synchronization. A data synchronization method of a terminal will be described in detail with reference to the flowchart of FIG. 3.

Data received from the terminal 7 may include image data, video data, sound source data, URL data, document (text, PDF, HTML, etc.) data, a file or a save file of an application, such as a game, etc.

If a playback tool (for example, a player, an application, a codec, etc.) for playing data received from the terminal 7 is not present in the terminal 5, the controller 40 may download the playback tool from the server 8.

If a playback tool is present in terminal 5, but a received file does not suit a playback environment of the terminal 5, the controller 40 may autonomously perform data conversion. If data conversion cannot be autonomously performed, the controller 40 may download a data conversion tool from a server 8 to perform synchronization.

In other words, the terminal 5, according to an exemplary embodiment, receives data to be synchronized after being directly connected to the terminal 7 based on the IP address, determines whether the received data suits the playback environment of the terminal 5, and performs a downloading operation if the received data does not suit the playback environment of the terminal 5, thereby improving compatibility with the terminal 7.

FIG. 3 is a flowchart illustrating a method for data synchronization according to an exemplary embodiment. Although depicted as being performed serially, those skilled in the art will appreciate that at least a portion of the operations of the method of FIG. 3 may be performed contemporaneously, or in a different order than presented in FIG. 3.

In operation 100, the terminal 5, according to an exemplary embodiment, directly accesses the terminal 7 based on the IP address. In operation 102, the terminal 5 receives data to be synchronized. The controller 40 determines the type of the received data and determines if a playback tool appropriate for reproduction of the data is present in the terminal 5, in operation 104.

If it is determined that a playback tool is not present, the controller 40 accesses a server through the communication unit 10 and searches for a suitable playback tool in operation 106. For example, the terminal 5 may perform may search the internet for an appropriate playback tool. In operation 108, the controller 40 determines if a suitable playback tool was searched for in operation 106. If a suitable playback tool was found as a result of the search in operation 108, the playback tool is downloaded in operation 110. If a suitable playback tool was not found as a result of the search in operation 108 for, in operation 130, a synchronization failure ACK signal is transmitted to the terminal 7.

The playback tool may be a codec if the received data is video data, or may be an application if the received data is a save file of an application, such as a game.

A process of searching for a codec in the case in which the received data is video data will now be described. The controller 40 searches for the playback tool using, for example, three pieces of field information: name, platform and type. The name may be changed based on what is being searched for, e.g., a codec, an application, or other tool. A name of a codec is used in the case in which a codec is searched for, and a title of an application or tool is used in the case in which an application or other tool is searched for. The platform refers to platform information of a target terminal 5, which will receive data to be synchronized. The type refers to the type of data to be searched for and, for example, may be set as a codec in the case of a search for a codec. If the codec is searched for using this process, the controller 40 displays information regarding the searched codec on the display unit 30 and asks a user whether the searched codec is to be downloaded. The codec may be downloaded in response to a user command or may be downloaded automatically.

A process of searching for an application if the received data is a save or file data of an application will now be described.

Similar to a search for codec, the controller 40 uses, for example, three pieces of field information to search for an application: the name of the application (e.g., a game), the platform (e.g., android) of the terminal 5, and a type field. The controller 40 searches for an application appropriate for the save or file data. In general, since file data is compatible between heterogeneous platforms, it is possible to search for a playable application if the search is performed on a platform basis. If the type field is an application, a search space may be an application store of the platform. Similar to the search for a codec, the controller 40 asks a user whether a highest search result is to be downloaded or may download one of the search results automatically. The application may be received from the terminal 7, which is the host terminal that hosts the data, in response to a user command.

Referring again to FIG. 3, if the received data may be played back in the terminal 5, the controller 40 determines whether the received data needs to be converted in operation 112. If it is determined that the received data needs to be converted, it is determined whether the data can be autonomously converted in operation 114. If it is determined that the data can be autonomously converted, the controller 40 autonomously converts the data into a format appropriate for the playback environment of the terminal 5, in operation 116.

If it is determined that the data cannot be autonomously converted, the controller 40 searches for a conversion tool for converting the received data into a format appropriate for the playback environment of the terminal 5 through the server 8 in operation 118. In operation 120, the controller 40 determines whether a suitable conversion tool was searched for.

If a suitable conversion tool was found as a result of the search, in operation 122, the conversion tool is downloaded. The data is converted using the downloaded conversion tool in operation 124. If the suitable conversion tool was not found as a result of the search, a synchronization failure ACK signal is transmitted to the terminal 7 in operation 130.

If the terminal 5 autonomously converts the data, or downloads the suitable conversion tool from the server 8 and converts the data, the received data is stored to complete synchronization in operation 126. A synchronization completion ACK signal is transmitted to the terminal 7 in operation 128.

Several examples of the above data conversion process will now be described. However, aspects of the present invention are not limited thereto. First, it is assumed that the received data is image data. For example, a JPEG image having a resolution of 800×480 of the terminal 7, which is a host terminal, is synchronized with a target terminal 5 having a resolution of 480×320.

If the JPEG image having resolution of 800×480 is transmitted from the terminal 7 to the terminal 5, the terminal 5 receives a header of the JPEG image file. The header information is read before the entire image is transmitted, and a determination as to whether conversion is needed for image playback in the terminal 5 is made. If conversion is needed, a body field is received and a conversion process is performed, thereby completing synchronization. The conversion process may be completed simultaneously with the receipt of the body field or after receipt of the body field.

The case in which the received data is video data will be described. The terminal 7, which is a host terminal, may have moving image data at a 1024×768 resolution, which may be played back by an H.264 codec and may be synchronized with the terminal 5. Two parameters need to be considered for synchronization: image resolution and performance. First, image resolution is considered. The image resolution may be autonomously converted by the terminal. If only resolution conversion is needed, a similar process as described above with regards to image processing may be performed. A 0×08 of an audio visual information (AVI) header may include width information and height information. The width information and height information is read and, if conversion is needed, a body field of the AVI is received and a conversion process is performed according to a playback environment of the terminal 5, thereby performing synchronization. The conversion process may be completed simultaneously with the receipt of the body field or after receipt of the body field.

Second, performance is considered. Since microprocessor control units (MCUs) differ according to a terminal, a limit value for processing an image may differ between two terminals. In a terminal, such as a smart phone, resource management is important. Thus, for resource optimization, upon video synchronization, a header of a video, a data rate, a frame rate, etc., are received and a determination as to whether the terminal can smoothly reproduce the video is made. If conversion is needed, similarly, body field reception and conversion are performed, thereby performing synchronization. The conversion process may be completed simultaneously with the receipt of the body field or after receipt of the body field. If a codec of the terminal 5 is different from the codec of the terminal 7, as described above, a needed codec is searched for through a server 8 and is downloaded, thereby performing synchronization.

The received data, such as video data, may include playback information (playback time, preference, etc.) and may be managed by a separate log file. Accordingly, if a common player is used by the terminal 5 and the terminal 7, the playback information of the received data may be extracted from the log file to perform synchronization. Using the extracted playback information, the terminal 5 may perform an operation, such as a continuous reproduction operation of the synchronized data.

The synchronization of the terminal 5 according to an exemplary embodiment is based on a request and grant between the terminal 7, which is a host of the data to be synchronized and the terminal 5. The controller 40 of the terminal 5 may determine an automation level for synchronization according to the type of each terminal and user setting.

Synchronization may be classified into: passive synchronization, half active synchronization, and fully active synchronization. Passive synchronization allows for both a process of requesting synchronization by the terminal 5 of the terminal 7 and a process for granting synchronization to the target terminal 5 to occur passively. In other words, the terminal 5 may be set to request synchronization only when instructed by a user and the terminal 7 may be set to grant synchronization requests from the terminal 5 only in response to a user instruction. A method for half active synchronization refers to synchronization with a host terminal in which one of the terminals automatically performs synchronization and the other does not. Half active synchronization may include waiting for synchronization at the target terminal 5, searching for a host through random confirmation of a user at the target terminal 5, and selecting one of the searched hosts and performing synchronization with the selected host. Fully active synchronization refers to performing synchronization in which both terminals automatically perform synchronization. In fully active synchronization, after a specific period of time synchronization may occur automatically between the terminal 5 and the terminal 7. A method for fully active synchronization may include the host terminal 7 waiting for a response from a target terminal 5, which performs pooling within a specific period, sending a synchronization request to the terminal 7, and synchronization occurring when the terminal 7 receives the request.

If the terminal 5 is a smart phone, according to an exemplary embodiment, and is synchronized to a TV or a PC, the fully active synchronization method may be applied such that data used in the smart phone, which is a mobile terminal, is synchronized with a TV or PC, which is a fixed terminal, without a separate operation. The TV may be in a polling state with a predetermined period and automatically performs synchronization if a host terminal is found. A user can use data in the synchronized TV again. This method is may be used in an image continuous play operation.

Using the half active synchronization, a host terminal instructs a target terminal to request synchronization of an original medium of the host terminal. The target terminal is set to automatically grant the instruction and requests synchronization to the host terminal, thereby performing synchronization. This is referred to as reversed half active synchronization. In other words, in half active synchronization, a host terminal automatically waits for synchronization and a terminal selects a host terminal to be synchronized. In contrast, in reversed half active synchronization, a terminal automatically waits for synchronization and a host terminal selects a terminal to be synchronized.

In an exemplary embodiment, if a terminal is a TV or a PC and a 802.11n wireless LAN adaptor supporting Wake-on LAN (WOL) is in a suspend state, a host terminal may transmit a wake-up signal to the TV or the PC and instructs synchronization. After data transmission, the TV or PC may return to a halt state. If aspects of the present invention are applied to synchronization waiting, it may be possible to perform automatic synchronization even in the halt state without a separate operation of the TV or the PC.

In a terminal and a synchronization method using the same according to aspect of the present invention a terminal is directly connected to another terminal based on an IP address without a separate server. If needed, data is converted or a playback tool or a conversion tool may be downloaded from a server so as to perform synchronization. Therefore, it is possible to improve compatibility with another terminal.

In a terminal and a synchronization method using the same according to aspect of the present invention, it is possible to perform high-speed synchronization regardless of a traffic status of a server by performing synchronization without a separate server based on an IP.

In addition, it is possible to improve compatibility with another terminal by receiving a tool for playing data from a server and performing synchronization.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a communication unit configured to transmit data to and/or receive data from a server or a second terminal; and
a controller configured to directly receive data of the second terminal through the communication unit based on an Internet Protocol (IP) and convert the received data into a format appropriate for a playback environment of the terminal to perform synchronization.

2. The terminal according to claim 1, wherein, if the received data cannot be directly converted into the format appropriate for the playback environment of the terminal, the controller receives a data conversion tool from the server through the communication unit and converts the received data using the received data conversion tool.

3. The terminal according to claim 1, wherein, if the terminal cannot reproduce the received data, the controller receives a playback tool from the server through the communication unit and performs synchronization of the received data using the received playback tool.

4. The terminal according to claim 1, wherein, if the terminal employs a 3G communication scheme, the controller receives an IP address from an IP server for storing IP information through the communication unit, acquires an IP address of the second terminal, and directly receives data of the second terminal.

5. The terminal according to claim 1, wherein, if the terminal employs a 4G communication scheme, the controller directly receives data from the second terminal through a unique IP address.

6. The terminal according to claim 1, wherein the IP is IEEE 802.11.

7. The terminal according to claim 1, wherein the received data is at least one of image data, video data, sound source data, URL data, document data and application data.

8. The terminal according to claim 7, wherein, if the received data is video data, the controller converts a size of the image data or converts at least one of resolution, a data rate and a frame rate of the video data.

9. The terminal according to claim 1, further comprising:
a display unit to display converted data.

10. A data synchronization method, the method comprising:
directly accessing a terminal through a communication unit based on an Internet Protocol (IP);
receiving data from the terminal;
determining whether the received data is appropriate for a playback environment; and
if the received data is not appropriate for the playback environment, converting the received data into a format appropriate for the playback environment.

11. The data synchronization method according to claim 10, wherein the converting the received data into the format appropriate for the playback environment comprises:
receiving a data conversion tool from a server through the communication unit; and
converting the received data using the received data conversion tool.

12. The data synchronization method according to claim 10, further comprising:
receiving a playback tool from a server through the communication unit; and
if the received data is not appropriate for the playback environment, performing synchronization of the received data using the received playback tool.

13. The data synchronization method according to claim 10, wherein the IP is IEEE 802.11.

14. The data synchronization method according to claim 10, wherein the data is at least one of image data, video data, sound source data, URL data, document data and application data.

15. The data synchronization method according to claim 14, wherein, if the data is video data, the converting the received data into the format appropriate for the playback environment comprises converting at least one of a size of the image data, a resolution, a data rate and a frame rate of the video data.

16. A data synchronization method, the method comprising:
directly accessing a terminal through a communication unit based on an IP;
receiving data from the terminal;
determining whether the received data appropriate for a playback environment;
receiving a playback tool from a server through the communication unit, if it is determined that the received data is not appropriate for the playback environment; and
performing synchronization of the received data using the received playback tool.

17. The data synchronization method according to claim 16, wherein the received data is application data and the playback tool is an application using the application data.
